(19) United States
(12) Patent Application Publication
(10) Pub. No.: US 2002/0041588 A1
(43) Pub. Date: Apr. 11, 2002

(54) Method and apparatus for network dialing for voice switching

(76) Inventor: Daniel L. Gleneck, Nashua, NH (US)

Correspondence Address: CHRISTIE, PARKER & HALE, LLP, 350 WEST COLORADO BOULEVARD, SUITE 500, PASADENA, CA, 91105, US

(21) Appl. No.: 09/927,631

(22) Filed: Aug. 10, 2001

Related U.S. Application Data
(60) Provisional application No. 60/224,567, filed on Aug. 10, 2000.

(51) Int. Cl. H04L 12/66

(52) U.S. Cl. 370/352; 370/401

(57) ABSTRACT

A network dialing scheme for voice switching is provided. The network dialing scheme provides method and apparatus for reducing the configuration requirements and complexity of configuring H.323 gateways on an H.323 network. The network dialing scheme also provides an user-friendly interface. The configuration of the H.323 gateway may be done using ASCII text files that can be distributed to multiple machines with little or no modifications. In the network dialing scheme, numbering plans are defined in which destinations are related with phone groups.

### CROSS-REFERENCE TO RELATED APPLICATION(S)

The present application claims the priority of U.S. Provisional Application No. 60/224,567 entitled “Voice Switching Module Configuration Interfaces Software System Design Specification” filed Aug. 10, 2000, the contents of which are fully incorporated by reference herein.

### FIELD OF THE INVENTION

The present invention is related to voice switching, and more particularly to a method and apparatus for network dialing for voice switching.

### BACKGROUND OF THE INVENTION

Voice over Internet Protocol (VoIP) H.323 networks typically use one or more dialing schemes to place a call from one H.323 gateway to another. There are two types of H.323 networks that are typically used. The first type is an H.323 network with a centralized H.323 gatekeeper, and the second type is an H.323 network without a centralized H.323 gatekeeper.

Each H.323 gateway can have more than one phone connected to it. In a typical H.323 VoIP phone call, there are two parties to the phone call: the caller (source point) and the called party (destination point). The caller is the person or device that originates a call while the called party is the person or device that receives the call. This device can be a normal analog telephone or phone like device, e.g., with a speaker and a microphone. Each of the caller and the called party typically has a unique phone number. Both Parties can have more than one unique phone number assigned to it.

Sometimes the phone call is made from one H.323 gateway to another H.323 gateway, and this is typically referred to as an H.323 Voice over IP (VoIP) phone call. The H.323 gateway that handles the caller is typically referred to as a source H.323 gateway, and the H.323 gateway that handles the called party is typically referred to as a destination H.323 gateway. At other times, the complete phone call is handled locally on a single H.323 gateway, and this is typically referred to as a local H.323 phone call. In this case, the same device comprises both the source H.323 gateway and the destination H.323 gateway. As a result, the single H.323 gateway handles both the caller and the called party in this case.

In a H.323 network, each gateway typically maintains two separate dialing plans: 1) one dialing plan for outgoing H.323 calls and 2) a separate dialing plan for local calls. Some H.323 gateways can maintain three dialing plans: 1) one dialing plan for outgoing H.323 calls, 2) one dialing plan local calls, and 3) one dialing plan for incoming H.323 calls. In some H.323 gateways, all three dialing plans can be co-mingled into one master dialing plan.

Configuration requirements for the H.323 gateways on an H.323 network are often complex. An H.323 network can comprise of many H.323 gateways, and many H.323 devices. Some, but not all H.323 networks may include an optional H.323 gatekeeper. In addition, user interface with the H.323 gateways is often complicated and cumbersome. Further, each H.323 gateway on the network typically is configured independently of other H.323 gateways on the network. Thus, there are many different dialing plans that need to be configured on a typical H.323 network. When configuring the H.323 network, each H.323 gateway can have different dialing plans including, without limitation, local, incoming, outgoing and H.323 gatekeeper.

If one or more of these dialing plans are combined, then this further complicates the configuration. If the user uses an H.323 gatekeeper, then the dialing plan is configured differently than if the user does not use it. The user must configure each and every one of these dialing plans. If the user wants to modify his H.323 network, he should typically be concerned about other H.323 gateways on the network and what changes he will need to make to each and every H.323 gateway. Thus, the user typically needs to keep track of all this information and configure multiple devices in multiple different ways. This can be a time consuming and complex process.

Therefore, it is desirable to develop a method and apparatus for network dialing, which is less complex, more user friendly, and in which multiple H.323 gateways can be configured with less effort than it takes to program each H.323 gateway independently.

### SUMMARY

Accordingly, in an embodiment according to the present invention, a method of configuring a plurality of gateways on a voice switching network is provided. A first gateway is configured using one or more commands. The configuration of the first gateway is stored into a file. The file is modified by modifying at least one of the commands. A second gateway is configured using the file.

In another embodiment according to the present invention, a voice switching network comprising a plurality of gateways is provided. A first gateway is configured using one or more commands. The first gateway comprises first memory for storing the commands into a file, and a second gateway comprises second memory. The file containing the commands is modified by modifying at least one of the commands, and the modified file is stored in the second memory, and is used to configure the second gateway.

In yet another embodiment of the present invention, a method of network dialing on a voice switching network is provided. One or more groups of phone numbers are defined. At least one group of phone numbers is associated with a numbering plan, and a destination is associated with the numbering plan. The destination is related to the group of phone numbers associated with the numbering plan.

### BRIEF DESCRIPTION OF THE DRAWINGS

These and other aspects of the invention may be understood by reference to the following detailed description, taken in conjunction with the accompanying drawings, which are briefly described below:

FIG. 1 illustrates an H.323 VoIP network with a centralized H.323 Gatekeeper, in which an embodiment according to the present invention may be applied;

FIG. 2 illustrates an H.323. VoIP network without a centralized H.323 Gatekeeper, in which an embodiment according to the present invention may be applied;

FIG. 3 illustrates a configuration of VoIP network dialing plans on an H.323 network without a centralized H.323 Gatekeeper, in which an embodiment according to the present invention may be applied;

Appendix A (70 pages) entitled “Network Dialing Schemes” describes information on selecting and configuring VoIP network dialing schemes used to translate dialed digits into IP addresses on a switch in an embodiment according to the present invention; and

Appendix B (284 pages) entitled “VoIP Commands” describes information on using VoIP command line interface (CLI) to configure VoIP switches in an embodiment according to the present invention.

### DETAILED DESCRIPTION

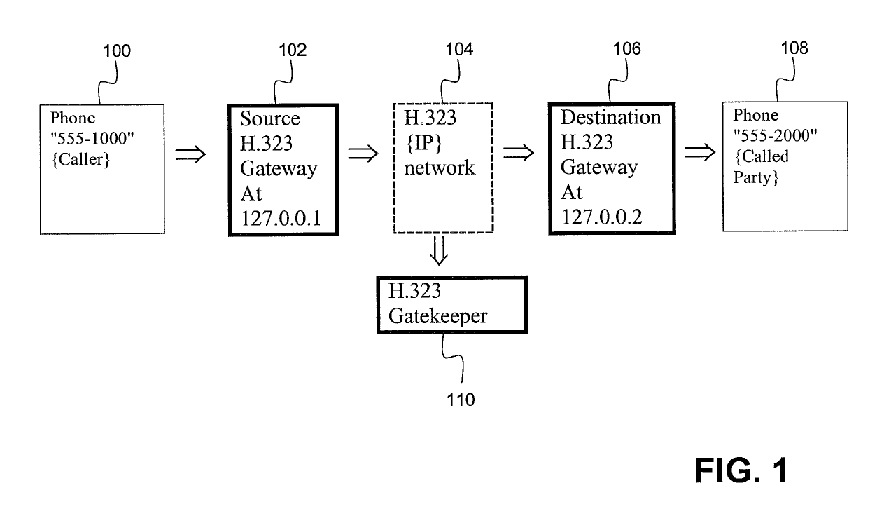

FIG. 1 illustrates an H.323 VoIP phone call process on an H.323 network with a centralized H.323 Gatekeeper, in which an embodiment according to the present invention may be applied. An H.323 Gatekeeper or a gatekeeper is a central registration device that contains routing information. The H.323 network of FIG. 1 may include any other type of central registration device instead of the centralized H.323 Gatekeeper.

In FIG. 1, a source gateway 102 (source H.323 gateway) has a source IP address 127.0.0.1, and a destination gateway 106 (destination H.323 gateway) has a destination address 127.0.0.2. A gateway or an H.323 gateway may refer to a VoIP daughter card, which preferably is used to provide VoIP capability to an IP network. VoIP daughter cards may be installed in a chassis of a switch. VoIP daughter cards may also be installed on another module, such as, for example, a voice switching module (VSM), and said another module may be installed in the chassis of the switch. VoIP daughter cards may either be a digital device (e.g., Voice Switching Digital daughter card (VSD)) or an analog device (e.g., Voice Switching Analog daughter card (VSA)).

In addition, a caller's phone (“caller”) 100 connected to the source gateway 102 has a phone number 555-1000, and a called party's phone (“called party”) 108 connected to the destination gateway 106 has a phone number 555-2000. In other embodiments, of course, the source and destination gateways may have different IP addresses, and the caller and the called party may have different telephone numbers. In addition, one or both the source and destination gateways may have other telephones connected to them.

Further, a network (H.323 IP network) 104 is interconnected between the source and destination gateways 102, 106, and a gatekeeper (H.323 gatekeeper) 110 is connected to the network 104. The network 104 in practice may actually include the source and destination gateways 102, 106 and the gatekeeper 110 as well as other gateways, gatekeepers, and other network devices.

In a typical H.323 VoIP phone call for the H.323 network of FIG. 1, when a H.323 gateway (either the source or the destination gateway) is added (e.g., powered up) on the network, it preferably is programmed to register the phone numbers of all the phones that are connected to it. For example, the source gateway 102 registers that it has a phone at “555-1000” and an IP address of 127.0.0.1 with the gatekeeper 110, and the destination gateway registers that it has a phone at “555-2000” and an IP address of 127.0.0.2 with the gatekeeper 110. The phone numbers that each H.323 gateway registers with the gatekeeper is programmed into each individual H.323 gateway.

The gatekeeper 110 preferably keeps a database of all gateways, their IP addresses, and phone numbers (dialed digits) that each gateway supports. The translation between phone numbers and IP addresses in the gatekeeper 110 may be referred to as an H.323 gatekeeper dialing plan or as a gatekeeper dialing plan.

In FIG. 1, the gatekeeper 110 is responsible for a dialing plan translation, which is a process of translating the digits into an IP address, of all outgoing calls from the gateway (source or destination gateway) onto the network 104. Each of the source and destination gateways 102, 106 should be configured to handle both the incoming (or local) and the outgoing dialing plans, which may be different from one another. Sometimes these dialing plans are stored as separate dialing plans, and at other times, they are stored as a single combined dialing plan.

The following is a brief overview of the typical sequence of events that takes place in the network of FIG. 1 to make a VoIP phone call on the network 104 with the centralized gatekeeper 110.

1) The caller 100 dials a sequence of digits representing the called party (108)'s telephone number, e.g., 555-2000.

2) The source gateway 102 preferably checks its local dialing plan to see how to route the telephone number (e.g., 555-2000) dialed by the caller 100. If it is a local telephone number, then the source gateway 102 uses the local dialing plan information to route the call. If it is not a local telephone number (which is the case here), then the source gateway 102 preferably consults the outgoing dialing plan as described in step 3).

3) The outgoing dialing plan for the source gateway 102 preferably is configured to request the gatekeeper 110 to perform the dialing plan translation, which is a process of translating the digits into an IP address. The source gateway 102 preferably asks the gatekeeper 110 for the IP address of the destination gateway 106 connected to the called party 108.

4) The gatekeeper 110 preferably uses the dialed phone number (e.g., 555-2000) to perform the dialing plan translation to look up the IP address of the destination gateway 106. The performing of the dialing plan translation by the gatekeeper 110 may sometimes be referred to as an H.323 gatekeeper dialing plan or as a gatekeeper dialing plan. In the above example, the gatekeeper 110 preferably returns 127.0.0.2 to the source gateway 102 as the IP address of the destination gateway 106.

5) The source gateway 102 preferably uses this IP address to contact the destination gateway 106, and informs the destination gateway 106 that it has a call for 555-2000.

6) When the destination gateway 106 receives the call, it preferably uses its local dialing plan to figure out how to route the call to the correct physical telephone. In this case, the local dialing plan may be referred to as an incoming dialing plan since it is being used to handle routing of incoming calls.

7) When it is ready, the destination gateway 106 preferably responds to the source gateway 102 that it is ready to receive the actual call.

8) When the call comes in the destination gateway 106, the destination gateway 106 preferably then routes the call to the correct telephone, and the called party (108)'s phone rings.

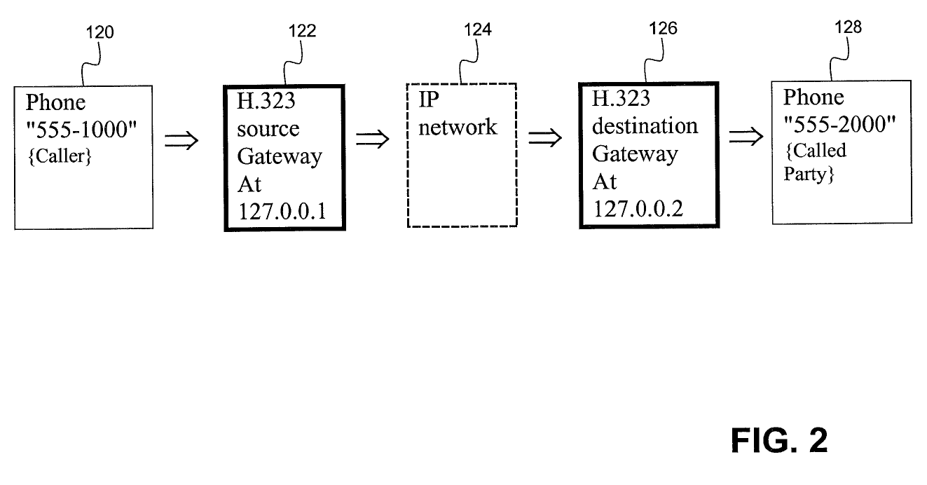

FIG. 2 illustrates an H.323 VoIP phone call process on an H.323 network without a centralized H.323 Gatekeeper, in which an embodiment according to the present invention may be applied. In FIG. 2, a source gateway 122 (source H.323 gateway) has a source IP address 127.0.0.1, and a destination gateway 126 (destination H.323 gateway) has a destination address 127.0.0.2. In addition, a caller's phone (“caller”) 120 connected to the source gateway 122 has a phone number 555-1000, and a called party's phone (“called party”) 128 connected to the destination gateway 126 has a phone number 555-2000. In other embodiments, of course, the source and destination gateways may have different IP addresses, and the caller and the called party may have different telephone numbers. In addition, one or both the source and destination gateways may have other telephones connected to them.

Further, a network (H.323 IP network) 124 is interconnected between the source and destination gateways 122, 126. The network 124 in practice may actually include the source and destination gateways 122, 126 as well as other gateways, gatekeepers, and other network devices.

The following is a brief overview of the typical sequence of events that takes place in the network of FIG. 2 to make a VoIP phone call on the network 124 without a centralized gatekeeper.

1) The caller 120 preferably dials a sequence of digits representing the called party (128)'s telephone number, e.g., 555-2000.

2) The source gateway 122 preferably checks its local dialing plan to see how to route the telephone number dialed by the caller 120, e.g., 555-2000. If it is a local telephone number, then it preferably uses the local dialing plan information to route the call. On the other hand, if it is not a local telephone number (which is a case here), then the source gateway 122 preferably consults an outgoing dialing plan as described in step 3) below.

3) The outgoing dialing plan for the source gateway 122 preferably is configured with IP addresses and phone numbers of all gateways on the network 124. When a new gateway is added to the network, every gateway on the network 124 preferably is manually updated. In most existing dialing plan processes, each gateway typically has different customized dialing plans.

4) The source gateway 122 preferably uses the outgoing dialing plan to perform the dialing plan translation, which is a process of translating the digits into an IP address. The source gateway 122 preferably looks up the called party's phone (e.g., 555-2000). If a match is found in the outgoing dialing plan, then the source gateway 122 preferably retrieves the corresponding IP address of the destination gateway 126 connected to the called party. The dialing plan translation process in this case preferably returns 127.0.0.2 as the IP address of the destination gateway 126 to the source gateway 122.

5) The source gateway 122 preferably uses this IP address to contact the destination gateway 126 to inform the destination gateway that it has a call for the called party 128.

6) When the destination gateway 126 is ready to handle the call, it preferably responds that it is ready to receive the actual call.

7) When the destination gateway 126 receives the actual voice call over the network 124, it preferably uses its local dialing plan to figure out how to route the call to the correct physical telephone of the called party 128. If an incoming dialing plan is present, then it would use the incoming dialing plan instead of the local dialing plan.

8) When the IP packets (representing the voice portion of the call) comes into the destination gateway 126, the destination gateway preferably then uses its local dialing plan to routes the call to the called party (128)'s telephone.

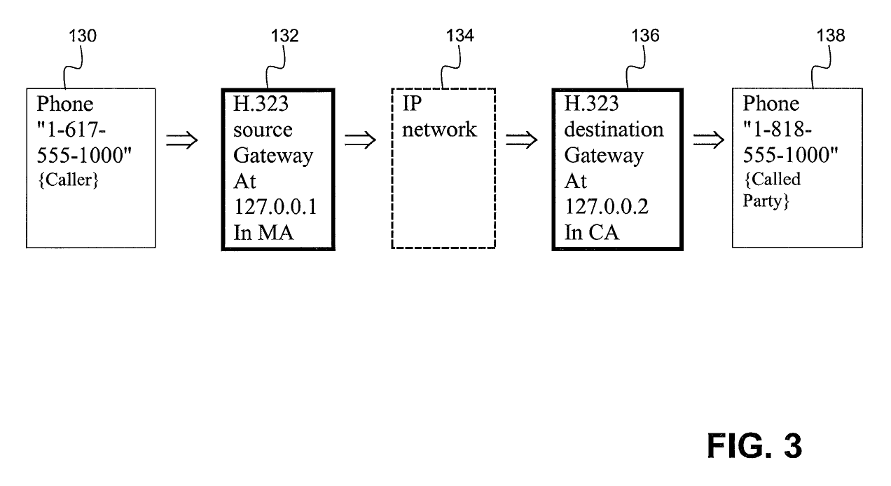

FIG. 3 illustrates a configuration of VoIP network dialing plans on an H.323 network without a centralized H.323 Gatekeeper, in which an embodiment according to the present invention may be applied. In FIG. 3, a source gateway 132 (source H.323 gateway) has a source IP address 127.0.0.1, and a destination gateway 136 (destination H.323 gateway) has a destination address 127.0.0.2. The source gateway 132, for example, may be located in Massachusetts (MA), while the destination gateway 136, for example, may be located in California (CA).

Further in FIG. 3, a caller's phone (“caller”) 130 connected to the source gateway 132 has a phone number 1-617-555-1000, and a called party's phone (“called party”) 138 connected to the destination gateway 136 has a phone number 1-818-555-1000. In other embodiments, of course, the source gateway may also be connected to phone(s) having a phone number 1-617-555-1001 and/or other suitable phone numbers. In addition, in other embodiments, the destination gateway may also be connected to phone(s) having a phone number 1-818-555-1001 and/or other suitable phone numbers. Further, in other embodiments, the source and destination gateways may have different IP addresses and/or locations, and the caller and the called party may have different telephone numbers.

Further, a network (H.323 IP network) 134 is interconnected between the source and destination gateways 132 and 136. The network 134 in practice may actually include the source and destination gateways 132, 136 as well as other gateways, gatekeepers, and other devices.

In the case where multiple telephones are coupled to the source gateway 132 and/or the destination gateway 136, each phone preferably can call every other phone. The caller at 1-617-555-1000 (or any other phone connected to the source gateway 132) can call the called party's phone 138 by dialing 1-818-555-1000. The called party (who becomes a caller in this case) at 1-818-555-1000 (or any other phone connected to the destination gateway 136) can call the caller's phone (who becomes a called party in this case) by dialing 1-617-555-1000. The caller at 1-617-555-1000 (or any other phone connected to the source gateway 132) can call himself by dialing 1000 (or other corresponding number). The called party at 1-818-555-1000 (or any other phone connected to the destination gateway 136) can call himself by dialing 1000 (or other corresponding number).

The source gateway 132 may have the following outgoing dialing plan: 1) the phone number 1-818-555-1000 should be sent to a remote gateway with the IP address of 127.0.0.2; and 2) the first 7 digits should be stripped off of the phone number before forwarding (so that only the last 4 digits are sent to the remote gateway, which in this case would be the destination gateway 136.

The source gateway 132 may also have the following local dialing plan: 1) the phone number 1-617-555-1000 should be sent to a local phone; and 2) the phone number 1000 should be sent to a local phone.

The destination gateway 136 may have the following outgoing dialing plan: 1) the phone number 1-617-555-1000 should be sent to a remote gateway with the IP address of 127.0.0.1; and 2) the first 7 digits should be stripped off of the phone number before forwarding (so that only the last 4 digits are sent to the remote gateway, which is this case would be the destination gateway 136).

The destination gateway 132 may also have the following local dialing plan: the phone number 1-818-555-1000 should be sent to a local phone; and 2) the phone number 1000 should be sent to a local phone.

In an embodiment according to the present invention, a method and apparatus are provided for reducing the configuration requirements and complexity of H.323 gateways on an H.323 network. Additionally, the present invention may provide a user interface that is easy to understand. Further, the configuration of the H.323 gateway may be done using ASCII text files that can be distributed to multiple machines with little or no modification.

Instead of each gateway having many different dialing plans, in an embodiment according to the present invention, one big network dialing scheme is created and used. In one embodiment, the network dialing scheme of the present invention may be referred to as Alcatel Voice over IP (VoIP) Network Dialing Scheme (AVNDS), which is available from Alcatel Internetworking, Inc.

The network dialing scheme of the present invention preferably is the same for all H.323 gateways on the entire H.323 network. Because the user does not configure individual dialing plans, but treats the H.323 network as one entity, the method and apparatus should better be referred to as a scheme rather than as a plan. The network dialing scheme of the present invention is easier to use than typical dialing plans because the user is better able to describe what he wants in the real world using a single unified scheme.

The user typically needs to know: 1) what telephone number should be used, and 2) where do each of these telephone numbers end up? Then with this knowledge, the user may create the network dialing scheme, and may use the same network dialing scheme configuration on each H.323 device, and each H.323 device preferably calculates (through programming) what the end result that the user wants to do and automatically configures itself to accomplish this goal.

The network dialing scheme may use an ASCII text file that contains groups of words (which may be referred to herein as CLI (Command Line Interface) commands). The ASCII text file preferably is capable of being distributed to multiple machines (network devices, such as VoIP daughter cards) with little or no modifications, and may result in reduction in complexity, cost and time involved in configuring an H.323 network. In other embodiments, binary files may be used instead of, or in addition to, the ASCII text file. The details of using CLI commands to configure VoIP switches may be found in Appendix B entitled “VoIP Commands,” the contents of which are fully incorporated by reference herein.

The CLI commands may comprise one or more of the following six parts:

1) IP address of the VoIP H.323 gateway;

2) H.323 destinations;

3) Local destinations;

4) phone groups;

5) numbering plans; and

6) associate a phone group with an H.323 gateway by sending the phone group information to a H.323 gatekeeper.

The above six parts of the CLI commands may be described as follows.

1) To configure IP address of the VoIP H.323 gateway in an embodiment according to the present invention, the following CLI command, for example, may be used:

“voice daughter card <slot number>/<card number> ip address <ip_address>”

The VoIP capability in this embodiment may be provided by adding a VoIP daughter card (e.g., voice switching daughter card, voice daughter card, VSD, VSA, or H.323 gateway) to a network device, e.g., a switch (e.g., OmniAccess 512 switch available from Alcatel Internetworking, Inc.). VoIP daughter cards that operate as H.323 gateways are also available from Alcatel. This command may be used to assign IP address to the VoIP daughter card.

The “slot number” field (e.g., 4) may represent the chassis slot number where the VSM is installed, and the “card number” field (e.g., 1) may represent the position of the voice daughter card on the VSM. In addition, the “ip address” field may represent the IP address for the voice daughter card, which may be in the form of xxx.xxx.xxx.xxx. Of course, the specific command may be different in other embodiments as long as the command is used to configure the IP address of an H.323 gateway for VoIP applications. Further, in other embodiments, other commands may be use to configure IP addresses of H.323 gateways.

2) H.323 destinations describe the physical H.323 device and what the IP address of the H.323 destination gateway is. To configure the H.323 destination, the following CLI command may be used in an embodiment according to the present invention:

“voice destination <endpointDestName> h.323 endpoint <address> [port]”

The above “voice destination h.323 endpoint” command may be used in this embodiment to create an endpoint destination with specified name that uses the H.323 protocol. The “endpointDestName” field may identify a voice call endpoint destination string name (e.g., to_vsd1), which preferably is used uniquely across the H.323 network.

The “address” field may specify an H.323 transport address, which may be an IP address or an H.323 network address and may be in a form of xxx.xxx.xxx.xxx. The “port” field may represent an H.323 port address, and may, for example, include four digits. Of course, the specific command may be different in other embodiments as long as the command is used to create an endpoint destination with specified name. Further, in other embodiments, other commands may be use to create and/or manipulate the endpoint destinations.

3) Local destinations in an embodiment according to the present invention are physical locations on an H.323 gateway device where the user plug in a telephony device including, without limitation, telephone, fax machine, PBX, and the like. To configure the local channel destination, the following CLI command may be used in this embodiment:

“voice destination <channelDestName> local channel <endpointDestName>/<port>/<startChannel-endChannel>”

The above “voice destination local channel” command may be used in this embodiment to create a local channel destination with a specified name. The “channelDestName” field may identify a voice call endpoint destination by name (e.g., tolosangeles). The “endpointDestName” field preferably is similar to the case of the voice destination h.323 endpoint command.

The “port” field may specify a physical port number (e.g., 1) on a voice daughter card. The “startChannel” and “endChannel” fields may specify the first number (e.g., 1) and the last number (e.g., 30), respectively, in a range of voice channels. Of course, the specific command may be different in other embodiments as long as the command is used to create a local channel destination with the specified name. Further, in other embodiments, other commands may be use to create and/or manipulate the local channel destinations.

4) Phone groups may be used in an embodiment according to the present invention to group together related groups of phone numbers. To configure the phone groups, the following CLI commands may be used. Of course, the specific commands may be different in other embodiments as long as the commands are used to configure the phone groups as described below. Further, other embodiments may also include other commands to configure the phone groups.

a) “voice phone group <PhoneGroupName>”

The above “voice phone group” command may be used in this embodiment to create a container to store and/or give a name to each related group of phone numbers. The “PhoneGroupName” field may be used to identify a phone group by name (e.g., losangeles_buddies).

b) “voice phone group <PhoneGroupName> site prefix {on|off}”

The above “voice phone group site prefix” command may be used in this embodiment to specify if the user wants (on) or do not want (off) a site prefix for the phone group (or phone number), for routing VoIP calls. This command may also add this information into the phone group container. In North America, the site prefix is usually a “1” followed by the area code and central office exchange. An example of a site prefix is “1-818-870”. Further, in other embodiments, site prefixes may be referred to as “trunk groups”, “trunk codes”, “routing prefixes”, “trunk prefixes” or any other terminology commonly used by those skilled in the art.

c) “voice phone group <PhoneGroupName> site prefix digits <string>”

The above “voice phone group site prefix digits” command may be used to specify what the site prefix for the phone number is, for routing VoIP calls. This command may also add the site prefix information into the phone group container. The “string” field may identify a phone group prefix string (e.g., 81). For example, when the phone group prefix string is 81, whenever the digits 81 are pressed from any channel on the network, a certain number of digits is expected to follow. Thus, a caller would dial 81306, for example, to get to extension 306 from anywhere in the VoIP network.

d) “voice phone group <PhoneGroupName> type local extensions”

The above “voice phone group type” command may be used to specify that the phone number is a local extension. This command may also add this information into the phone group container. Local extension may indicate use of intra-VoIP network (PBX) extensions between 1 and 11 digits. Further, in other embodiments, more or less digits may be used. An example of a local extension is “1000”. When a telephone number is used to place a call inside the same physical site, from room to room, local extensions are usually used.

e) “voice phone group <PhoneGroupName> type NANP extensions”

The above “voice phone group type” command may be used to specify that the phone number is a North American Numbering Plan (NANP) extension, e.g., NANP intra-VoIP network (PBX) extension. This command may also add this information into the phone group container. An example of a NANP extension is: “1-603-555-1234”, where “1-603-555” is the site prefix, and “1234” is the local extension.

f) “voice phone group <PhoneGroupName> type international extensions”

The above “voice phone group type” command may be used to specify that the phone number is an international extension, e.g., international intra-VoIP network (PBX) extension. This command may also add this information into the phone group container. An example of an international extension is “001-33-1-555-1234”, where “001-33-1-555” is the site prefix, and “1234” is the local extension.

g) “voice phone group <PhoneGroupName> type NANP PSTN”

The above “voice phone group type” command may be used to specify that this phone number is to be used as “all other” telephone numbers not configured as “NANP extension”. For example, this command may indicate use of NANP via the PSTN, which may comprise local and long distance domestic telephone numbers. Thus, this command may be used to connect up to the NANP PSTN (local telephone company). This command may also add this information into the phone group container.

h) “voice phone group <PhoneGroupName> type international PSTN”

The above “voice phone group type” command may be used to specify that this phone number is to be used as “all other” telephone numbers not configured as “International extension”. This command may be used to connect up to the international PSTN. In other words, this command may indicate use of international long distance telephone via the PSTN. This command may also add this information into the phone group container.

i) “voice phone group <PhoneGroupName> format <formatString>”

The above “voice phone group format” command may be used to specify the format (length) of phone number and number of outbound digits to dial for a phone group. This command may also add this information into the phone group container. For example, “XXXX” may indicate that the phone number is four digits long. For another example, “XXXX??” may indicate that the phone number can be 4, 5, or 6 digits long. Further, in other embodiments, other characters other than “X” or “?” may be used.

j) “voice phone group <PhoneGroupName> strip digit length <num>”

The above “voice phone group strip digit length” command may be used to specify a number of outbound (collected) digits to strip in phone group before forwarding the call. This command may also add this information into the phone group container.

k) “voice phone group <PhoneGroupName> forwarding prefix {on|off}”

The above “voice phone group forwarding prefix command” may be used to specify if the user wants (on) or do not want (off) to add digits in front of the phone number before forwarding the call. This command may also add this information into the phone group container.

l) “voice phone group <PhoneGroupName> forwarding prefix digits <PrefixNum>”

The above “voice phone group forwarding prefix digits” command may be used to specify the digits that should to be added in front of the phone number before forwarding the call. This command may also add this information into the phone group container.

m) “voice phone group <PhoneGroupName> usage {voice|fax|modem} {on|off}”

The above “voice phone group usage” command may be used to specify how the phone numbers are going to be used: for voice (normal telephone), for fax, or for (computer) modem. This command may also be used to specify whether or not the phone numbers are actually going to be used or not. If they are actually going to be used, they should be turned on, and if not, they should be turned off, by a user, for example. This command may also add this information into the phone group container. Further, in other embodiments, “usage data” may be used.

n) “voice phone group <PhoneGroupName> add numbers <StartRange> [[thru] EndRange]”

The above “voice phone group add numbers” command may be used to specify the digits of the phone numbers to include in range of digits for phone format string. For example, all numbers between the “StartRange” field (e.g., 1000) and the “EndRange” field (e.g., 1999) may be included in the range of digits. This command may also add this information into the phone group container.

o) “voice phone group <PhoneGroupName> delete numbers <StartRange> [[thru] EndRange]”

The above “voice phone group delete numbers” command may be used to specify the digits of the phone numbers to exclude in range of digits for phone format string. For example, all numbers between the “StartRange” field (e.g., 1100) and the “EndRange” field (e.g., 1199) may be excluded from the range of digits. This command may also add this information into the phone group container. For example, “1000” thru “1999” are included using the “voice phone group add numbers” command, and then “1100” thru “1199” are excluded using the “voice phone group delete numbers” command, the range of “1000” thru “1099” and “1200” thru “1999” results.

5) Numbering plans may be used to relate one or more phone groups with one or more destinations, which may be either local or H.323, so that the H.323 gateway knows what phone numbers are related with what physical phones. If the user configures more than one destination, the numbering plans may be used to determine the order of the destinations.

To configure the numbering plans, the following CLI commands may be used in an embodiment according to the present invention. Of course, the specific commands may be different in other embodiments as long as the commands are used to relate one or more phone groups with one or more destinations as described below. Further, other embodiments may also include other commands to relate the phone groups with the destinations.

a) “voice numbering plan <NumberingPlanName>”

The “voice numbering plan” command may be used to create a container to store, give a name to, and to relate phone groups with destinations. The “NumberingPlanName” field preferably identifies the numbering plan by name.

b) “voice numbering plan {all|activate NumberingPlanName}”

The above “voice numbering plan activate” command may be used to instruct the H.323 gateway to actually use the specified numbering plan as part of the network dialing scheme, such as, for example, AVNDS network dialing scheme available from Alcatel Internetworking, Inc. If this command is not present, then this number plan may be created, but may not be used as a part of the network dialing scheme. When the switch “all” is used, all numbering plans may be activated at once.

c) “voice numbering plan <NumberingPlanName> hunt method {round robin|top down}”

The above “voice numbering plan hunt method” command may be used to determine the hunt order of the destinations. For example, the “round robin” switch may indicate that the numbering plan uses round robin hunting method to find open lines for incoming calls. For another example, the “top down” switch may indicate that the numbering plan uses top down hunting method to find open lines for incoming calls. Further, in other embodiments, other types of hunt method may be used.

d) “voice numbering plan <NumberingPlanName> description <string>”

The above “voice numbering plan description” command may be used to describe the numbering plan for future reference. The “string” field, for example, may be a text string that describes the specified voice numbering plan.

e) “voice numbering plan <NumberingPlanName> associate destination member <DestName>”

The above “voice numbering plan associate destination member” command may be used to relate a specific destination with the specified numbering plan. The user may relate one or more destination with a single numbering plan. The order that these are in, for example, may determine the hunting order. The “associate” switch may indicate association of the specified numbering plan with the specified destination member. Of course, the specific commands may be different in other embodiments as long as the commands are used to relate one or more destinations with a numbering plan as described above.

f) “voice numbering plan <NumberingPlanName> disassociate destination member <DestName>”

The above “voice numbering plan disassociate destination member” command may be used to un-relate a specific destination with the specified numbering plan. If the specific destination has previously been associated with the specified number, then this command may be used to remove the association. The “disassociate” switch may indicate disassociation of the specified numbering plan with the specified destination member.

g) “voice numbering plan <NumberingPlanName> associate phone group member <PhoneGroupName>”

The above “voice numbering plan associate phone group member” command may be used to relate a specific phone group with the specified numbering plan. The user may relate one or more phone group with a single numbering plan. The “associate” switch may indicate association of the specified phone group with the specified numbering plan. Of course, the specific commands may be different in other embodiments as long as the commands are used to relate one or more phone groups with a numbering plan as described above.

h) “voice numbering plan <NumberingPlanName> disassociate phone group member <PhoneGroupName>”

The above “voice numbering plan disassociate phone group member” command may be used to un-relate a specific phone group with the specified numbering plan. If the phone group has previously been associated, then this command may be used to remove the association. The “disassociate” switch may indicate disassociation of the specified phone group with the specified numbering plan.

6) If the user is using an H.323 gatekeeper on the H.323 VoIP network, then a “voice network h.323 gatekeeper associate” command may be used to determine what phone numbers an H.323 gateway should give to the H.323 gatekeeper upon power on of the H.323 gateway. The “voice network h.323 gatekeeper associate” command for associating a phone group with the H.323 gateway may have the following god format: “voice network card slot/card_number H.323 gatekeeper associate phone group <phoneGrpName>”

This command may be used to associate one or more phone groups of the H.323 gateway with the H.323 gatekeeper, thereby enabling the H.323 gateway to generate the list of telephone numbers that it supports and give them to the H.323 gatekeeper upon its power up. Of course, the specific commands may be different in other embodiments as long as the commands are used to associate a phone group with an H.323 gateway. Further, other embodiments may also include other commands to associate and/or to disassociate one or more phone groups with one or more H.323 gateways.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof are intended to be embraced therein.

For example, even though the present invention has been described mainly in reference to H.323 protocol, the embodiments of the present application are broadly applicable to networks using any other VoIP protocols including, without limitation, Session Initiated Protocol (SIP), Medial Gateway Control Protocol (MGCP), and the like. In these and other VoIP networks, H.323 gateways and H.323 gatekeepers and other H.323 specific devices may be replaced and/or complemented by other VoIP devices that support the other VoIP protocols. Further, VoIP devices using different protocols may be coupled to and simultaneously operate in the same VoIP network.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

I claim:

1. A method of configuring a plurality of gateways on a voice switching network, the method comprising the steps of:
configuring a first gateway using one or more commands;
storing the configuration for the first gateway into a file;
modifying the file by modifying at least one of the commands; and
configuring a second gateway using the file.

2. The method according to claim 1, wherein the voice switching network is a Voice over Internet Protocol (VoIP) network, and the gateways comprise VoIP gateways.

3. The method according to claim 2, wherein the VoIP network is an H.323 network, a Session Initiated Protocol (SIP) network or a Medial Gateway Control Protocol (MGCP) network, and the gateways comprise H.323 gateways, SIP gateways or MGCP gateways depending on the type of the VoIP network.

4. The method according to claim 1, wherein the file comprises a binary file.

5. The method according to claim 1, wherein the file comprises an ASCII text file.

6. The method according to claim 1, wherein the commands comprise a command for assigning an IP address to at least one gateway or to a network device.

7. The method according to claim 6, wherein the network device is a VoIP device.

8. The method according to claim 1, wherein the commands comprise a command for associating a destination gateway with a unique identifier.

9. The method according to claim 8, wherein the unique identifier comprise an IP address, an H.323 address, a SIP address or an MGCP address.

10. The method according to claim 1, wherein the commands comprise a command for creating a local channel destination with a specified name.

11. The method according to claim 1, wherein the commands comprise one or more commands for defining one or more groups of related phone numbers, and for configuring said groups of related phone numbers.

12. The method according to claim 1, wherein the commands comprise one or more commands for defining one or more containers, and for configuring the containers.

13. The method according to claim 12, wherein the containers are used to store phone groups and destinations, and to relate the phone groups with the destinations.

14. The method according to claim 13, wherein the containers comprise numbering plans.

15. The method according to claim 1, wherein the voice switching network comprises a central registration device that contains routing information, and the commands comprise a command for associating one or more phone groups of the gateways with the central registration device.

16. The method according to claim 15, wherein the voice switching network is a VoIP network, and the central registration device is a gatekeeper.

17. A voice switching network comprising:
a plurality of gateways, a first gateway being configured using one or more commands, the first gateway comprising first memory for storing the commands into a file, and a second gateway comprising second memory,
wherein the file containing the commands is modified by modifying at least one of the commands, and wherein the modified file is stored in the second memory and is used to configure the second gateway.

18. The voice switching network according to claim 17, wherein the voice switching network is an VoIP network, and the gateways comprise VoIP gateways.

19. The voice switching network according to claim 18, wherein the VoIP network is an H.323 network, a Session Initiated Protocol (SIP) network or a Medial Gateway Control Protocol (MGCP) network, and the gateways comprise H.323 gateways, SIP gateways or MGCP gateways depending on the type of the VoIP network.

20. The voice switching network according to claim 17, wherein the file comprises a binary file.

21. The voice switching network according to claim 17, wherein the file comprises an ASCII text file.

22. The voice switching network according to claim 17, wherein the commands comprise a command for assigning an IP address to at least one gateway or to a network device.

23. The voice switching network according to claim 22, wherein the network device is a VoIP device.

24. The voice switching network according to claim 17, wherein the commands comprise a command for associating a destination gateway with a unique identifier.

25. The voice switching network according to claim 24, wherein the unique identifier comprises an IP address, an H.323 address, a SIP address or an MGCP address.

26. The voice switching network according to claim 17, wherein the commands comprise a command for creating a local channel destination with a specified name.

27. The voice switching network according to claim 17, wherein the commands comprise one or more commands for defining one or more groups of related phone numbers, and for configuring said groups of related phone numbers.

28. The voice switching network according to claim 17, wherein the commands comprise one or more commands for defining one or more containers, and for configuring the containers.

29. The voice switching network according to claim 28, wherein the containers are used to store phone groups and destinations, and to relate the phone groups with the destinations.

30. The voice switching network according to claim 29, wherein the containers comprise numbering plans.

31. The voice switching network according to claim 17, the network further comprising a central registration device that contains routing information, and the commands comprise a command for associating one or more phone groups of the gateways with the central registration device.

32. The voice switching network according to claim 32, wherein the voice switching network is a VoIP netwrok, and the central registration device is a gatekeeper.

33. A method of network dialing on a voice switching network, the method comprising the steps of:
defining one or more groups of phone numbers;
associating at least one group of phone numbers with a numbering plan; and
associating a destination with the numbering plan, the destination being related to the group of phone numbers associated with the numbering plan.

34. The method of claim 33, wherein the numbering plan serves as a container for storing the group of phone numbers and the destination that are related to one another.

35. The method of claim 33, further comprising the step of translating an incoming phone number to a destination address using the numbering plan.
